(19) United States
(12) Patent Application Publication
(10) Pub. No.: US 2016/0180357 A1
(43) Pub. Date: Jun. 23, 2016

(54) METHOD FOR ESTIMATING CRUDE OIL PRODUCTION

(71) Applicant: Genscape Intangible Holding, Inc., Louisville, KY (US)

(72) Inventors: Randall L. Collum, JR., Richmond, TX (US); Josef W. Spalenka, Louisville, KY (US); Deirdre Alphenaar, Prospect, KY (US); Brent Sundheimer, Louisville, KY (US)

(21) Appl. No.: 14/971,088

(22) Filed: Dec. 16, 2015

Related U.S. Application Data
(60) Provisional application No. 62/093,095, filed on Dec. 17, 2014.

(51) Int. Cl. G06Q 30/02

(52) U.S. Cl. CPC G06Q 30/0202

(57) ABSTRACT

In a method for estimating crude oil production, a geographic (or market) region is first identified and selected, and a value of natural gas pipeline activity for the region is determined. That value of natural gas pipeline activity for the region is then calibrated against historical crude oil production data for the region to establish a model for estimating the crude oil production for the region. Subsequently, as natural gas production data for a particular time period is received, it is input into the model to estimate crude oil production in the region, and that estimated crude oil production for the region and for the particular time period is reported to third-party market participants.

### CROSS-REFERENCE TO RELATED APPLICATIONS

The present application claims priority to U.S. Patent Application Ser. No. 62/093,095 filed on Dec. 17, 2014.

### BACKGROUND OF THE INVENTION

The present invention relates to methods for estimating crude oil production and/or crude oil prices.

Oil and gas occur in geologic formations with varying ratios of potentially producible oil and gas present in the formation. A particular geographic region may be primarily oil rich, primarily natural gas rich, or produce both oil and natural gas. In many geographic regions, strong inter-relationships exist between crude oil and natural gas production, and, in particular, crude oil production is strongly correlated with natural gas production. These geographic regions are not limited to on-shore production regions, but also include off-shore production regions, such as the Gulf of Mexico continental shelf region and the Sable Island Offshore region near Nova Scotia, Canada. Furthermore, natural gas production in this context can mean natural gas produced at the well-head, as well as natural gas and natural gas liquids resulting from upstream processing at natural gas processing facilities.

It thus would be advantageous to use available natural gas production data to estimate crude oil production for a selected geographic region.

### SUMMARY OF THE INVENTION

The present invention is a method for estimating crude oil production and/or crude oil prices for a selected geographic region based on an optimized model of natural gas production and pipeline activity for the same or an associated geographic region.

An exemplary implementation of the method of the present invention commences with the selection of a particular geographic region of interest.

After a particular geographic region has been selected, a value of natural gas pipeline activity for the region is determined. Such a determination requires reference to a database that includes natural gas production data that has been gathered and stored, including, but not necessarily limited to, natural gas pipeline flow and nominations data, oil-to-gas production ratios at wellheads and processing plants, geographical location data for wellheads and pipeline flow points, and pipeline infrastructure construction and maintenance intelligence data. Such data can be gathered from publicly available reports (e.g., daily natural gas pipeline nominations) and/or real-time sensors. A subset of such natural gas production data can then be chosen and optimized to determine the value of natural gas pipeline activity for the region.

For example, after a particular geographic region has been selected, a value for natural gas pipeline activity for the region may be determined from a subset of selected daily natural gas pipeline nominations. For instance, daily gas pipeline nominations can be scraped from natural gas operator postings published publicly on electronic bulletin boards.

With respect to the selection of the daily natural gas pipeline nominations (or other data) to be included in the subset, the objective is to select those specific pipeline points that are most closely correlated with crude oil production. Pipeline points can include, but are not limited to, points along a pipeline network associated with natural gas well-heads, natural gas storage facilities, natural gas pipeline meter and/or compressor stations, natural gas and natural gas liquid processing facilities, transmission pipeline interconnects, natural gas city-gates and industrial demand end-users, and other points whose cumulative data represents the balance of natural gas inbound or outbound from a particular geographic region strongly associated with crude oil production.

Furthermore, it should be recognized that, in the selection of the daily natural gas pipeline nominations (or other data) to be included in the subset, selection and optimization is a classification or sorting problem that is amenable to certain algorithmic techniques, such as machine learning and neural networks. The ultimate output of the machine learning classification or other classification/sorting algorithm are decisions for inclusion or exclusion of pipeline points in the subset.

Once the subset of natural gas production data has been chosen and the value of natural gas pipeline activity for the region has been determined, the next step is to calibrate the natural gas pipeline activity against historical crude oil production data, which results in the establishment of a model for estimating the crude oil production for the selected geographic region based on historical crude oil production data.

Once the crude oil production model has been established and optimized, as gas pipeline nominations or other natural gas production data are received for a particular day, those gas pipeline nominations or other natural gas production data are input into the crude oil production model to estimate crude oil production. The estimated crude oil production and/or crude oil price information is then reported to third-party market participants, i.e., third parties who would not ordinarily have ready access to such information.

### DESCRIPTION OF THE DRAWINGS

FIG. 1 is a flow chart illustrating an exemplary implementation of the method of the present invention;

FIG. 2 is a plot of an exemplary regression analysis for an initial (or trial) subset of pipeline points, where the x-axis is the overall activity of the selected subset of gas pipeline points, and the y-axis is the actual reported monthly crude oil production in a selected geographic region during the same time period;

FIG. 3 is a flow chart illustrating the input of gas pipeline nominations into a crude oil production model to estimate crude oil production in an exemplary implementation of the method of the present invention;

FIG. 4 is a plot of the modeled crude oil production for the Texas Permian Basin using daily gas pipeline nominations data;

FIG. 5 is another plot of the modeled crude oil production for the Texas Permian Basin using daily gas pipeline nominations data, where the model has been established using a machine learning decision forest regression technique; and

FIG. 6 is a plot of the modeled crude oil production for the Bakken, North Dakota region using daily gas pipeline nominations data against crude oil prices.

### DETAILED DESCRIPTION OF THE INVENTION

The present invention is a method for estimating crude oil production and/or crude oil prices for a selected geographic region based on an optimized model of natural gas production and pipeline activity for the same or an associated geographic region.

As discussed above, in many geographic regions, strong inter-relationships exist between crude oil and natural gas production, and, in particular, crude oil production is strongly correlated with natural gas production. These geographic regions are not limited to on-shore production regions, but also include off-shore production regions. With respect to the correlation between crude oil production and natural gas production, crude oil production (and, consequently, crude oil prices) for a selected geographic region can thus be estimated by choosing an optimized subset of natural gas production data for the same region, and then building a model calibrated to historical crude oil production data.

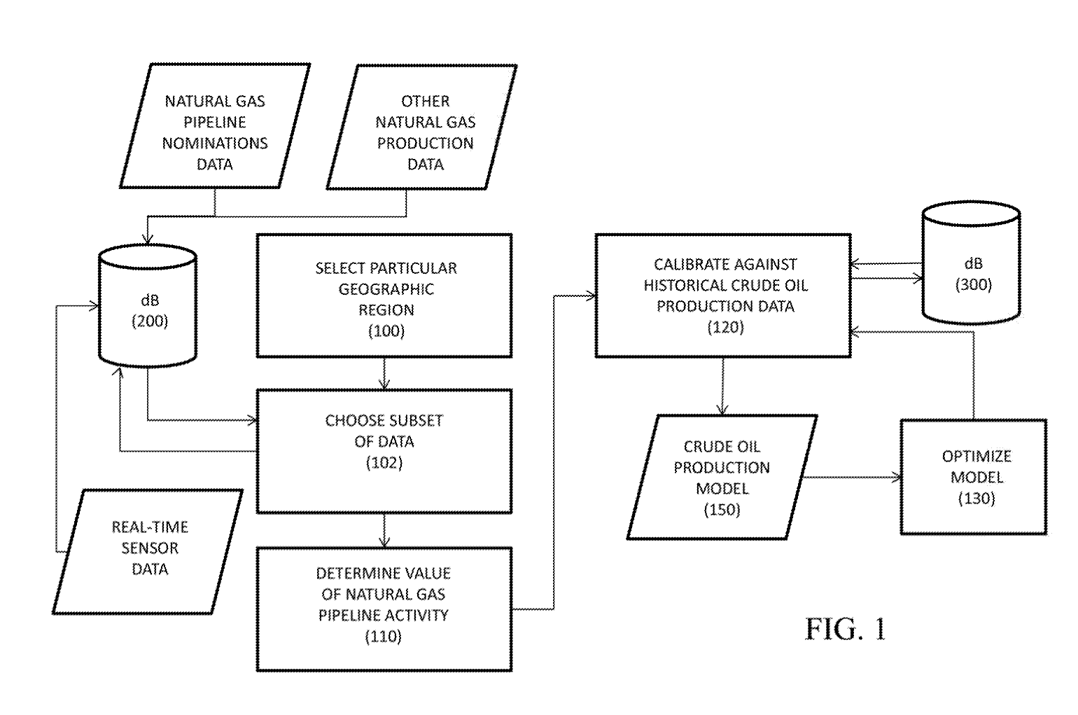

Referring now to FIG. 1, an exemplary implementation of the method of the present invention commences with the selection of a particular geographic region of interest, as indicated by block 100 of FIG. 1. In this regard, oil and gas producing regions, such as the Permian Texas, South Texas, and Denver-Julesburg, Colorado basins, are geographically defined based on county and state districts. In other words, entire counties are either included or excluded from the definition of the oil and gas producing region with no partial counties, so the definitions of oil producing regions are non-overlapping.

Furthermore, the definition of a geographical region could be determined by associating gas pipelines or sections of gas pipelines to specific crude oil production regions, areas associated with specific types of crude oil, and/or specific owner-operator networks. Alternatively, crude oil production regions can be automatically or dynamically defined using a Geographical Information System (GIS), which uses physical location data (e.g., latitude and longitude co-ordinates) on crude oil and gas wells, pipelines, pipeline metering, and/or receipt and delivery points (pipeline points), as well as processing and storage facilities along pipelines.

After a particular geographic region has been selected, a value of natural gas pipeline activity for the region is determined, as indicated by block 110 of FIG. 1. Such a determination requires reference to a database 200 that includes natural gas production data that has been gathered and stored, including, but not necessarily limited to, natural gas pipeline flow and nominations data, oil-to-gas production ratios at wellheads and processing plants, geographical location data for wellheads and pipeline flow points, and pipeline infrastructure construction and maintenance intelligence data. Such data can be gathered from publicly available reports (e.g., daily natural gas pipeline nominations) and/or real-time sensors. A subset of such natural gas production data can then be chosen, as indicated by block 102 of FIG. 1, and optimized to determine the value of natural gas pipeline activity for the region.

For example, after a particular geographic region has been selected, a value for natural gas pipeline activity for the region may be determined from a subset of selected daily natural gas pipeline nominations. Interstate pipelines, i.e., pipelines which cross one or more state lines, are mandated by the Federal Energy Regulatory Commission (FERC) Order No. 809 to report timely pipeline nominations flow data to the public. Such pipeline nominations are not real-time measurements of physical natural gas flows. Rather, they are day-ahead or intra-day contracted volumes of physical gas to be delivered to specific delivery and receipt points (which are also referred to as pipeline points) along the pipeline system.

For instance, daily gas pipeline nominations can be scraped from natural gas operator postings published publicly on electronic bulletin boards. For example, the electronic bulletin board for the El Paso Natural Gas Company, L.L.C., a Kinder Morgan company, can be accessed at the following URL: (http://passportebb.elpaso.com/ebbmasterpage/default.aspx?code=EPNG). Such daily pipeline nominations and/or any other available data are preferably collected from many such electronic bulletin boards from multiple natural gas pipeline operators, and then stored in a database, as indicated by reference number 200 in FIG. 1.

With respect to the selection of the daily natural gas pipeline nominations (or other data) to be included in the subset, the objective is to select those specific pipeline points that are most closely correlated with crude oil production. Pipeline points can include, but are not limited to, points along a pipeline network associated with natural gas well-heads, natural gas storage facilities, natural gas pipeline meter and/or compressor stations, natural gas and natural gas liquid processing facilities, transmission pipeline interconnects, natural gas city-gates and industrial demand end-users, and other points whose cumulative data represents the balance of natural gas inbound or outbound from a particular geographic region strongly associated with crude oil production. Although any pipeline point could, in principle, be used in a model to estimate crude oil production in a region, in practice, pipeline points associated with the residue gas at the outlet of gas processing plants and gathering system entry points into interstate and intrastate transmission pipelines are often the best indicators of crude oil production, rather than oil and gas movements and transfers of oil and gas that was produced outside of the geographic region of interest and is simply being transported through the geographic region.

Furthermore, it should be recognized that, in the selection of the daily natural gas pipeline nominations (or other data) to be included in the subset, selection and optimization is a classification or sorting problem that is amenable to certain algorithmic techniques, such as machine learning and neural networks. In this regard, inputs to a potential machine learning classification or other classification/sorting algorithm include, but are not limited to: Geographical Information System (GIS) location data of the candidate pipeline points with respect to producing wellhead locations; maximum flow capacities for each candidate pipeline point; type of pipeline point (e.g., gathering receipt, gas processing plant outlet, transmission pipeline interconnect, citygate delivery point, etc.); candidate pipeline point ownership; historic flow statistics of each candidate pipeline point; and data from automated sensors that spot-sample physical qualities at each candidate pipeline point, such as oil-to-gas ratios; transmission pipeline diameter; and maintenance and construction notices. The machine learning classification or other classification/sorting algorithm then introduces parameters and thresholding criteria that form the basis for including or excluding the candidate pipeline points from the final subset. An exemplary thresholding criterion might include a number of logical filtering statements such as “include pipeline points with at least 30 active producing well sites within 20 miles,” “exclude pipeline points whose diameter is less than 8 inches,” and/or “exclude pipeline points which are citygate delivery point.” Such logical filtering statements can either be implicitly determined (discovered) by an automated algorithm, or the filtering statements can be explicitly built in as fixed parameters. The ultimate output of the machine learning classification or other classification/sorting algorithm are decisions for inclusion or exclusion of pipeline points in the subset.

Again, once the subset of natural gas production data has been chosen, as indicated by block 102 of FIG. 1, a value of natural gas pipeline activity for the region is determined, as indicated by block 110 of FIG. 1.

For instance, if only daily natural gas pipeline nominations data is included in the subset, in some implementations, such daily pipeline nominations data is then summed to determine an aggregated value of overall daily pipeline activity within the subset. Furthermore, in some implementations, the daily values for aggregated pipeline activity at the selected pipeline points are then averaged together by month to produce a monthly value for overall natural gas pipeline activity in the subset. Alternative methods of aggregation include the use of weighted sums or weighted averages. In this regard, weighting factors could be optimized to make certain pipeline points more important than others based on criteria, such as, but not limited to: relative magnitude of production; known or measured oil-to-gas ratios sampled at different wellheads; observed activity from real-time sensors; known or determined effects on regional market price movements based on historic market price data; and metadata related to infrastructure construction announcements.

For sake of example, Table 1 shows characteristic daily pipeline nominations data for a series of pipeline points geographically located in the Texas Permian Basin. In this example, an initial subset of three pipeline points is chosen (indicated by a “YES” or “NO” logic value) from among the five available pipeline points, and then for each day that data was collected, the pipelines nominations data is summed to determine an aggregated value of overall daily pipeline activity within the subset for that day. Of course, in practice, a subset of arbitrary size may be chosen from among hundreds of available pipeline points for a selected oil and gas producing geographic region.

TABLE 1

| | Included in subset? | | | | | |
|---|---|---|---|---|---|---|
| | YES | NO | NO | YES | YES | |
| | Pipeline | Pipeline | Pipeline | Pipeline | Pipeline | Sum for |
| Date | Point 1 | Point 2 | Point 3 | Point 4 | Point 5 | subset |
| Jun. 26, 2013 | 24395 | 1402 | 23541 | 78570 | 73984 | 176949 |
| Jun. 27, 2013 | 28601 | 1402 | 23541 | 70330 | 69067 | 167998 |
| Jun. 28, 2013 | 28290 | 1898 | 23541 | 69517 | 66363 | 164170 |
| Jun. 29, 2013 | 47218 | 1898 | 23541 | 69450 | 66757 | 183425 |
| Jun. 30, 2013 | 41803 | 1898 | 23495 | 69383 | 66504 | 177690 |
| Jul. 1, 2013 | 35957 | 1383 | 17655 | 67811 | 59822 | 163590 |
| Jul. 2, 2013 | 33355 | 1583 | 16047 | 64971 | 72635 | 170961 |
| Jul. 3, 2013 | 42070 | 1583 | 16047 | 72529 | 77593 | 192192 |
| . . . | . . . | . . . | . . . | . . . | . . . | . . . |

Now, as mentioned above, in determining the value of overall daily pipeline activity for the region, other data may also be retrieved and considered, including data from real-time sensors. In such cases, a value for overall daily pipeline activity for the region may be determined from a subset selected from both the daily pipeline nominations dataset and real-time sensor data. In this regard, real-time sensors may be particularly important in gathering data about intrastate pipeline systems, i.e., pipelines which do not cross state lines and thus are exempt from publicly reporting pipeline nominations. Data can be gathered from these non-reporting intrastate pipeline systems by deploying real-time sensors to estimate flows and production at selected pipeline points. These sensors can target the pipeline infrastructure itself or other methods of real-time transportation of crude oil and/or gas, such as rail and truck transport. For example, U.S. Pat. No. 7,274,996 is entitled “Method and System for Monitoring Fluid Flow” and describes the measurement of acoustic waves to determine the flow rate of natural gas, crude oil, and/or other energy commodities. For another example, U.S. Pat. No. 7,376,522 is entitled “Method and System for Determining the Direction of Fluid Flow” and also relies on the measurement of acoustic waves to determine the direction of flow of natural gas, crude oil, and/or other energy commodities through a conduit. With respect to monitoring methods of real-time transportation, examples include: U.S. patent application Ser. No. 14/846,095, which is entitled “Method and System for Monitoring Rail Operations and Transport of Commodities Via Rail” and U.S. Patent Application Ser. No. 62/114,864, which is entitled “Method and System for Monitoring Energy Commodity Networks Through Radiofrequency Scanning.” Each of the foregoing patents and patent applications is incorporated herein by reference.

Referring again to FIG. 1, the next step is to calibrate the natural gas pipeline activity against historical crude oil production data, as indicated by block 120 of FIG. 1. Such historical crude oil production data can be acquired from a number of different sources, including, for example, from the Railroad Commission of Texas (http://www.rrc.state.tx.us/oil-gas/research-and-statistics/production-data/monthly-crude-oil-production-by-district-and-field/), and then stored in a database, as indicated by reference number 300 in FIG. 1. In most cases, such historical crude oil production data is not immediately available, but is made available a few weeks or months after production and is commonly reported in terms of an average daily crude oil production value for each month in units of barrels per day.

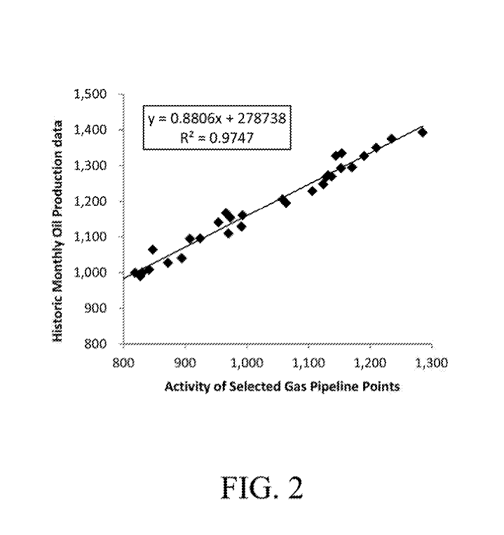

For example, to calibrate the aggregated values of overall daily pipeline activity as determined from the daily pipeline nominations data (FIG. 1) against publicly available historical crude oil production data, a linear regression analysis may be applied to a trial subset (or each of multiple subsets) of pipeline points against the calibrating data of historical crude oil production. FIG. 2 is a plot of an exemplary regression analysis for the initial (or trial) subset of pipeline points chosen above, where the x-axis is the overall activity of the selected subset of gas pipeline points in units of thousands of dekatherms per day, and the y-axis is the actual reported monthly crude oil production in the selected geographic region during the same time period in units of thousands of barrels per day. Each data point represents one month of data. Thus, the regression analysis results in a model for estimating the crude oil production for the selected geographic region based on historical crude oil production data, as indicated by output 150 in FIG. 1.

As a further refinement, to optimize the model, a subset of pipeline points is chosen from the full daily pipeline nominations dataset that maximizes a desired figure of merit, such as the value of the coefficient of determination, R², as indicated by block 130 of FIG. 1. Specifically, multiple subsets of pipeline points are chosen from the full daily pipeline nominations dataset, and the above-described linear regression analysis is applied to each subset until the coefficient of determination, R², is maximized. Such an optimization routine thus selects those nominations at specific pipeline points that are most closely correlated with crude oil production, while discarding the pipeline points at which natural gas and crude oil production are poorly correlated. Alternatively, various weighting factors can be applied as user-inputted constants or dynamically-generated variables to different pipeline points based on information derived from historical data analysis or real-time information on whether these pipeline points will strongly or weakly correlate with crude oil production. Such pipeline point weighting may also be affected by seasonal or transient effects, such as pipeline operations, weather, natural gas demand, market price, and localized pipeline construction and maintenance events. Of course, the model can also be periodically recalibrated and updated to reflect long-term changes in oil and gas infrastructure that affect the correlation between natural gas pipeline activity and crude oil production in a selected geographic region.

For another example, to calibrate the value of natural gas pipeline activity for the region against historical crude oil production data for the region, machine learning regression techniques could be used to establish the model for estimating the crude oil production for the region. Such techniques include decision forest regression, neural network regression, and boosted decision tree regression. In this regard, inputs to the machine learning regression techniques can include, but are not limited to: daily pipeline flow information, monthly pipeline flow information, monthly crude oil production, pipeline diameter, maximum flow rates, etc.

For instance, with respect to daily natural gas pipeline nominations data, such data could be aggregated into monthly gas flow data. This monthly gas flow data would then be compared against the monthly crude oil production reports which are publicly available. The machine learning regression algorithm would iteratively refine the model so that the plurality of monthly gas flow data would fit with the monthly crude production data. Of course, this model could then be updated over time to reflect the additional data that is generated over time with additional measurements and public releases of data.

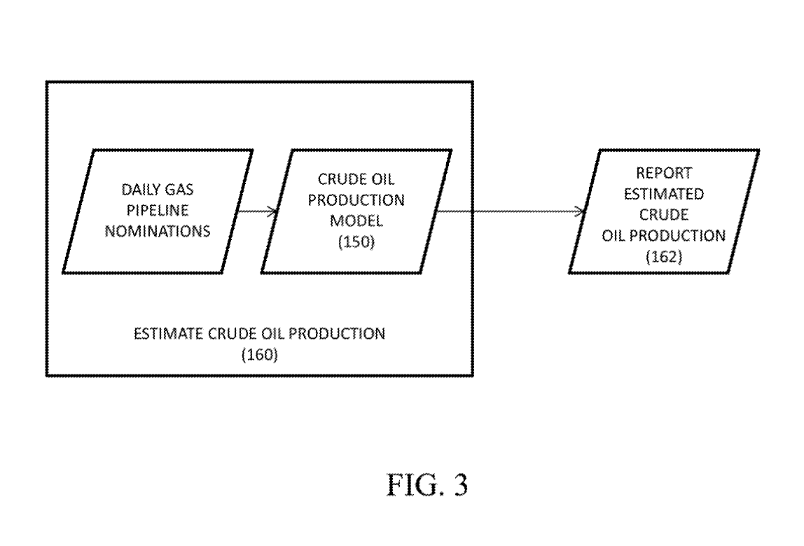

Referring now to FIG. 3, once the crude oil production model has been established and optimized, and then stored in a memory component of a computer, as gas pipeline nominations or other natural gas production data are received for a particular day, those gas pipeline nominations or other natural gas production data are input into the crude oil production model to estimate crude oil production, as indicated by block 160 in FIG. 2. The estimated crude oil production is then reported to third-party market participants, i.e., third parties who would not ordinarily have ready access to such information, as indicated by block 162 in FIG. 3.

The above-described operational and computational steps of this method are preferably achieved through the use of a digital computer program, i.e., computer-readable instructions stored and executed by a computer. Such instructions can be coded into a computer-readable form using standard programming techniques and languages, and with benefit of the above description, such programming is readily accomplished by a person of ordinary skill in the art.

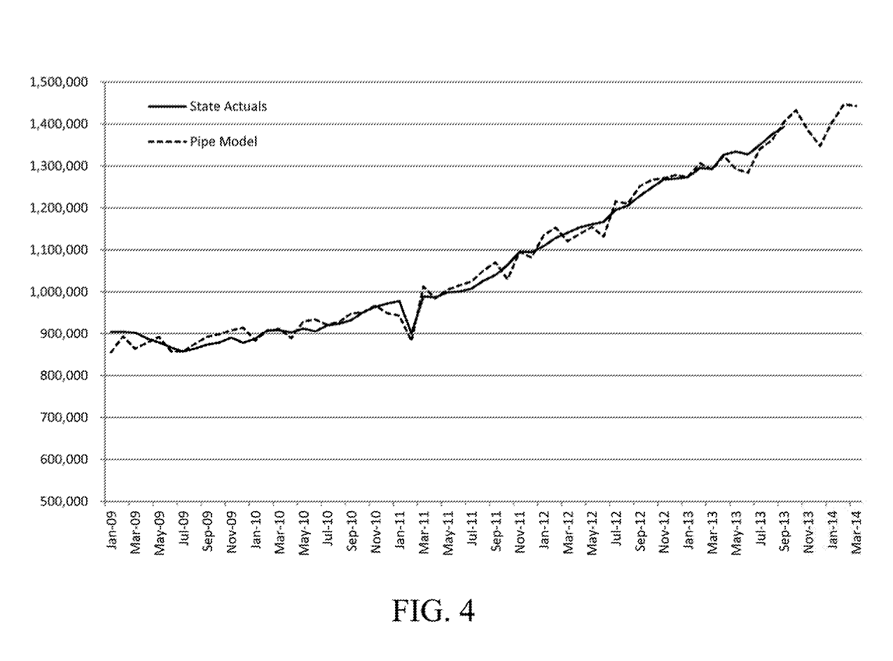

FIG. 4 is a plot of the modeled crude oil production for the Texas Permian Basin using daily gas pipeline nominations data. The model, which, as described above, is based on an optimized subset of natural gas pipeline points, is indicated by the dashed line, while the actual reported crude oil production for the Texas Permian Basin is indicated by the solid line for sake of comparison. Of course, as described above, the daily gas pipeline nominations allow for a daily estimate of crude oil production, while the actual reported crude oil production may not be available for weeks or months.

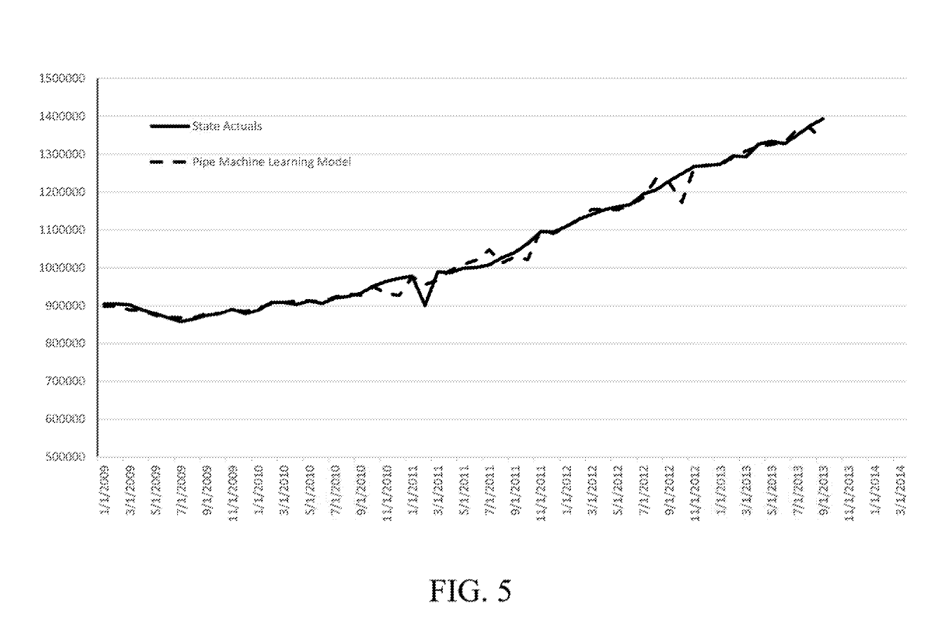

FIG. 5 is a plot of the modeled crude oil production for the Texas Permian Basin using daily gas pipeline nominations data, but, in this case, the model indicated by the dashed line is established using a machine learning decision forest regression technique as described above, while the actual reported crude oil production for the Texas Permian Basin is indicated by the solid line for sake of comparison.

It should be clear from the foregoing description that the methods described above can be extended to any oil and gas producing basin for which both historical crude oil production data and daily natural gas pipeline nominations data (or other natural gas production data) are available, including all oil and gas producing basins in North America.

In addition to defining production regions in terms of geographic areas of production, it is also possible to define production regions associated with specific operators, such as areas containing wells associated with specific well owner-operators or areas servicing certain pipeline networks. In addition, certain regions can be defined as being associated with certain types of crude oil (e.g., sour, sweet, etc.), and the production rates and volumes of specific crude oil types can then be associated with natural gas production in these areas.

By estimating crude oil production in the above-described manner, and putting this supply data together with market demand data associated with crude oil from certain geographic (or market) regions and pricing hubs, certain types of crude oil, and/or crude oil production by a specific owner-operator, an estimation of the effect of rates of production can be used to estimate prices or possible price movements, including predictions as to whether the price of crude oil is rising or falling.

In addition to supply and demand, the effect of physical phenomena, such as weather events or infrastructure disruption issues associated with crude oil transportation networks, can also be factored in and correlated to crude oil production, prices, and price movements. In conventional market pricing assessments for crude oil, regional market bids (bid by physical market sellers) and offers (offered by physical market buyers) are surveyed by various price assessment companies. The surveyed price data is then published periodically to market participants as an assessment of the current market price. These pricing assessments are, in turn, utilized by market participants as basis prices in term supply contracts or commodity exchange derivative transactions. Market price assessments represent a historical record of market bids and offers, as well as absolute prices and price movements. Fundamental data, such as crude oil production, crude oil transfer, and crude oil demand, ultimately influence and are reflected in the assessed market price. By comparing this surveyed price data with historic production data, relationships between supply, supply disruptions, and corresponding price movements can be modelled. Since the methods of the present invention provide a mechanism to estimate crude oil production in real-time, it follows that any modelled relationships between historic price, price movement, and crude oil production can also be extended into the real-time using the real-time natural gas production data.

One of ordinary skill in the art will recognize that additional implementations are also possible without departing from the teachings of the present invention. This detailed description, and particularly the specific details of the exemplary implementations disclosed therein, is given primarily for clarity of understanding, and no unnecessary limitations are to be understood therefrom, for modifications will become obvious to those skilled in the art upon reading this disclosure and may be made without departing from the spirit or scope of the invention.

What is claimed is:

1. A method for estimating crude oil production, comprising the steps of:
selecting a region;
determining a value of natural gas pipeline activity for the region;
calibrating the value of natural gas pipeline activity for the region against historical crude oil production data for the region to establish a model for estimating the crude oil production for the region;
receiving natural gas production data for a particular time period, and then inputting that natural gas production data into the model to estimate the crude oil production for the region; and
reporting the estimated crude oil production for the region for the particular time period to third-party market participants.

2. A computer-implemented method for estimating crude oil production for a region, comprising the steps of:
using a computer to determine a value of natural gas pipeline activity for the region by referencing a database of natural gas production data;
using the computer to calibrate the value of natural gas pipeline activity for the region against historical crude oil production data for the region by referencing a database of historical crude oil production data, thus establishing a model for estimating the crude oil production for the region;
storing the model for estimating the crude oil production for the region in a memory component;
receiving natural gas production data for a particular time period, and then inputting that natural gas production data into the model to estimate the crude oil production for the region; and
reporting the estimated crude oil production for the region for the particular time period to third-party market participants.

3. The method as recited in claim 2, wherein the database of natural gas production data comprises natural gas pipeline nominations data.

4. The method as recited in claim 2, wherein the database of natural gas production data includes data from real-time sensors at selected pipeline points in the region.

5. A method for estimating crude oil production, comprising the steps of:
selecting a region;
choosing a set of daily natural gas pipeline nominations data for the region;
determining a value of natural gas pipeline activity for the region from the set of daily natural gas pipeline nominations data;
calibrating the value of natural gas pipeline activity for the region against historical crude oil production data for the region to establish a model for estimating the crude oil production for the region;
receiving natural gas production data for a particular time period, and then inputting that natural gas production data into the model to estimate the crude oil production for the region; and
reporting the estimated crude oil production for the region for the particular time period to third-party market participants.

6. The method as recited in claim 5, wherein, in the step of choosing the set of daily natural gas pipeline nominations data for the region, pipeline points of interest are selected using a classification or sorting algorithm.

7. The method as recited in claim 5, wherein, in the step of determining the value of natural gas pipeline activity for the region, the daily pipeline nominations data is summed to determine the value of natural gas pipeline activity for the region.

8. The method as recited in claim 5, wherein, in the step of calibrating the value of natural gas pipeline activity for the region, a linear regression is applied to a subset of selected pipeline points against the historical crude oil production data for the region.

9. The method as recited in claim 5, and further comprising the step of optimizing the model for estimating the crude oil production for the region by choosing a subset of daily natural gas pipeline nominations data that maximizes a figure of merit.
